(19) United States
(12) Patent Application Publication
(10) Pub. No.: US 2026/0106375 A1
(43) Pub. Date: Apr. 16, 2026

(54) ELECTRONIC DEVICE INCLUDING ANTENNA

(71) Applicant: Samsung Electronics Co., Ltd., Suwon-si (KR)

(72) Inventors: Jaehyung KIM, Suwon-si (KR); Cheolhong Son, Suwon-si (KR); Taegyu Kim, Suwon-si (KR); Kwangseo Kim, Suwon-si (KR); Himchan Yun, Suwon-si (KR); Jesun Moon, Suwon-si (KR); Minseok Park, Suwon-si (KR); Jungkyu Lee, Suwon-si (KR)

(73) Assignee: Samsung Electronics Co., Ltd., Suwon-si (KR)

(21) Appl. No.: 19/400,262

(22) Filed: Nov. 25, 2025

Related U.S. Application Data
(63) Continuation of application No. PCT/KR2025/015194, filed on Sep. 26, 2025.

(30) Foreign Application Priority Data
Oct. 10, 2024 (KR) 10-2024-0137353
Nov. 12, 2024 (KR) 10-2024-0159973

(51) Int. Cl. H01Q 5/321; H01Q 1/24; H01Q 5/20

(52) U.S. Cl. CPC H01Q 5/321; H01Q 1/241; H01Q 5/20

(57) ABSTRACT

An electronic device includes: a substrate including wireless communication circuitry and a ground; and an antenna structure that at least partially overlaps the substrate. The antenna structure includes: a first radiator connected to the wireless communication circuitry through a first point of the substrate; and a second radiator connected to the ground through a second point of the substrate. The first radiator and the second radiator at least partially form a first coupling area. The substrate includes: a first conductive pad connected to the first point; and a second conductive pad connected to the second point. The first conductive pad and the second conductive pad at least partially form a second coupling area. The first coupling area and the second coupling area at least partially overlap. The wireless communication circuitry transmits or receives wireless signals in a plurality of frequency bands through the first radiator and the second radiator.

### CROSS-REFERENCE TO RELATED APPLICATIONS

This application is a by-pass continuation application of International Application No. PCT/KR2025/015194, filed on Sep. 26, 2025, which is based on and claims priority to Korean Patent Application No. 10-2024-0137353, filed on Oct. 10, 2024, and Korean Patent Application No. 10-2024-0159973, filed on Nov. 12, 2024, in the Korean Intellectual Property Office, the disclosures of which are incorporated by reference herein their entireties.

### TECHNICAL FIELD

The disclosure relate to an electronic device including an antenna.

### BACKGROUND ART

As the functional gap between manufacturers decreases, electronic devices are becoming slimmer to meet the needs of consumers. The rigidity of electronic devices is increasing and the design aspect is being strengthened and, at the same time, the electronic devices are being developed to differentiate their functional elements. An electronic device may include at least one antenna in an internal space for communication among components. A layout of the at least one antenna needs to be efficient while a radiation performance of the at least one antenna is maintained.

The above-described information may be provided as the related art to help understanding of the disclosure. No claim or determination is made as to whether any of the above-described contents is applicable as the prior art related to the disclosure.

### DISCLOSURE OF INVENTION

### Technical Problem

The antenna volume and/or the number of antennas used in an electronic device (e.g., portable communication device) may be determined based on a frequency, a bandwidth, and/or a type for each service. For example, the low band of about 600 MHz to 960 MHz, the mid band of about 1700 MHz to 2200 MHz, the high band of about 2300 MHz to 2800 MHz, or the high frequency band (e.g., 5G (NR)) (e.g., UHB/FR1, about 3.2 GHz to 4.5 GHz) of about 3 GHz to 300 GHz may be used as main communication bands. As another example, various wireless communication services, such as Bluetooth (BT), a global positioning system (GPS), or wireless fidelity (WIFI), may be used. To support the above-described communication bands, a plurality of antennas need to be included, while the space for antenna layout may decrease as the electronic device becomes slimmer or an area occupied by a display increases. To overcome the problem of decreased space for antenna layout, service bands with similar frequency bands may be designed to be grouped and separated into a plurality of antennas.

The electronic device may include an attachable antenna (e.g., metal foil antenna (MFA)) in internal space and provide to an internal structure (e.g., bracket or cover member) in an attachable manner. The attachable antenna may have a feed structure that performs individual feed to each radiator, for example, including a first radiator configured to operate in the low band and a second radiator configured to operate in the mid band and the high band. However, this individual feed structure may reduce the layout efficiency of a substrate, and may be difficult to implement the electronic device.

To solve this problem, the first radiator and the second radiator may be coupled, and having a feed structure in which only the first radiator is powered (e.g., coupling feed) may lead to improving the component layout efficiency.

However, in a case of the attachable antenna, a distance between two radiators is limited (e.g., up to about 0.5 mm) due to a manufacturing process (e.g., stamping process), and the radiation performance of the antenna may be degraded due to the insufficient coupling amount between the two radiators.

The disclosure provides an electronic device including an antenna that may help improve the radiation performance through an increase in the coupling amount of two radiators.

The disclosure provides an electronic device including an antenna that may help slimness of the electronic device while exhibiting the excellent radiation performance.

However, subjects to be accomplished by the disclosure are not limited to the above-described subjects and may be expanded in various manners without departing from the spirit and scope of the disclosure.

### Solution to Problem

According to an aspect of the disclosure, an electronic device includes: a housing; a substrate including wireless communication circuitry and a ground; and an antenna structure that at least partially overlaps the substrate, wherein the antenna structure includes: a first radiator electrically connected to the wireless communication circuitry through a first point of the substrate; and a second radiator electrically connected to the ground through a second point of the substrate, wherein the first radiator and the second radiator at least partially form a first coupling area, wherein the substrate includes: a first conductive pad electrically connected to the first point; and a second conductive pad electrically connected to the second point, wherein the first conductive pad and the second conductive pad at least partially form a second coupling area, wherein the first coupling area and the second coupling area at least partially overlap, and wherein the wireless communication circuitry is configured to transmit or receive wireless signals in a plurality of frequency bands through the first radiator and the second radiator.

According to an aspect of the disclosure, an electronic device includes: a substrate including wireless communication circuitry and a ground; and an antenna structure that at least partially overlaps the substrate, wherein the antenna structure includes: a first radiator electrically connected to the wireless communication circuitry through a first point of the substrate, and a second radiator electrically connected to the ground through a second point of the substrate, wherein the first radiator and the second radiator at least partially form a first coupling structure, wherein the substrate includes a second coupling structure in an electrical path that electrically connects the first point and the second point, wherein the first coupling structure and the second coupling structure at least partially overlap, and wherein the wireless communication circuitry is configured to transmit or receive wireless signals in a plurality of frequency bands through the first radiator and the second radiator.

### Advantageous Effects of Invention

According to example embodiments of the disclosure, An electronic device may include a first radiator having a feed structure and a second radiator closely provided to the first radiator to form a first coupling area (e.g., first coupling structure), and the first coupling area may include a single feed multi-band antenna provided to overlap a second coupling area (e.g., second coupling structure) provided to a substrate, thereby helping improve the radiation performance of an antenna (e.g., increase in gain and/or bandwidth expansion) through an increase in the coupling amount between the first and second radiators by the second coupling area.

In addition, various effects directly or indirectly identified through the present document may be provided.

Effects that may be acquired by the disclosure are not limited to the above-described effects and still other effects not described may be clearly understood by one of ordinary skill in the art to which the disclosure pertains from the following description.

### BRIEF DESCRIPTION OF DRAWINGS

In relation to description of drawings, the same or similar reference numerals may be used for the same or similar components.

FIG. 1 illustrates an electronic device within a network environment according to one or more embodiments of the disclosure;

FIG. 2A is a perspective view of the front surface of an electronic device according to one or more embodiments of the disclosure;

FIG. 2B is a perspective view of the rear surface of the electronic device of FIG. 2A according to one or more embodiments of the disclosure;

FIG. 3A is a partial perspective view of an electronic device including an antenna structure according to one or more embodiments of the disclosure;

FIG. 3B is a perspective view of an antenna structure according to one or more embodiments of the disclosure;

FIG. 3C is a configuration diagram of a substrate according to one or more embodiments of the disclosure;

FIG. 4 is a partially expanded view of an electronic device including a substrate and an antenna structure according to one or more embodiments of the disclosure;

FIG. 5 illustrates a layout structure of a substrate and an antenna structure viewed along line 5-5 of FIG. 3A according to one or more embodiments of the disclosure;

FIG. 6 is a graph comparing the radiation performance of the antenna of FIG. 4 depending on whether a second coupling area is provided according to one or more embodiments of the disclosure;

FIG. 7 is a partially expanded view of an electronic device including a substrate and an antenna structure according to one or more embodiments of the disclosure;

FIG. 8 is a graph comparing the radiation performance of the antenna of FIG. 7 depending on whether a second coupling area is provided according to one or more embodiments of the disclosure.

FIG. 9 is a graph comparing the radiation performance of the antenna of FIG. 7 depending on whether overlapping between a first coupling area and a second coupling area is present according to one or more embodiments of the disclosure;

FIG. 10 is a graph showing the radiation performance of the antenna FIG. 7 according to an increase in the coupling amount of a second coupling area according to one or more embodiments of the disclosure;

FIG. 11A is a partially expanded view of an electronic device including a substrate and an antenna structure according to one or more embodiments of the disclosure;

FIG. 11B is a graph comparing the radiation performance of the antenna of FIG. 11A according to a change in a capacitance value of a capacitor according to one or more embodiments of the disclosure;

FIG. 12 is a graph comparing the radiation performance of the antenna of FIG. 4 depending on whether a second coupling area is provided according to one or more embodiments of the disclosure;

FIG. 13 is a configuration diagram of a substrate according to one or more embodiments of the disclosure;

FIG. 14A is a partially expanded view of an electronic device including a substrate and an antenna structure according to one or more embodiments of the disclosure;

FIG. 14B is a configuration diagram of a variable circuit of FIG. 14A according to one or more embodiments of the disclosure;

FIG. 15A is a graph comparing the radiation performance of the antenna of FIG. 14A through control of a first variable circuit according to one or more embodiments of the disclosure;

FIG. 15B is a graph comparing the radiation performance of the antenna of FIG. 14A through control of a second variable circuit according to one or more embodiments of the disclosure; and

FIG. 15C is a graph comparing the radiation performance of the antenna through control of a variable circuit according to gripping of an electronic device according to one or more embodiments of the disclosure.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

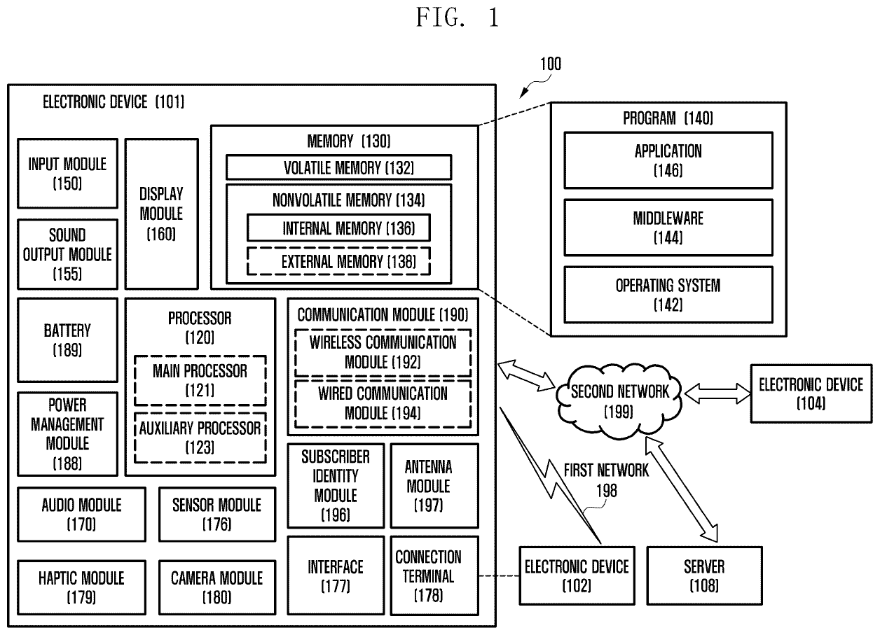

FIG. 1 is a block diagram illustrating an example electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

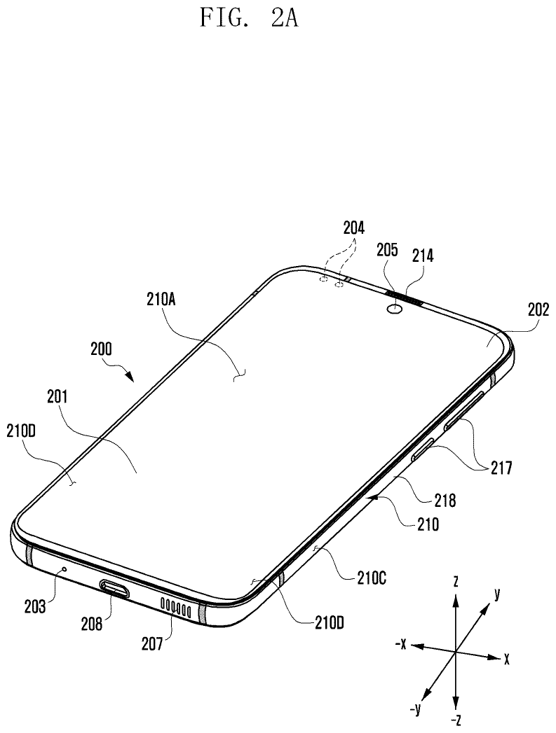

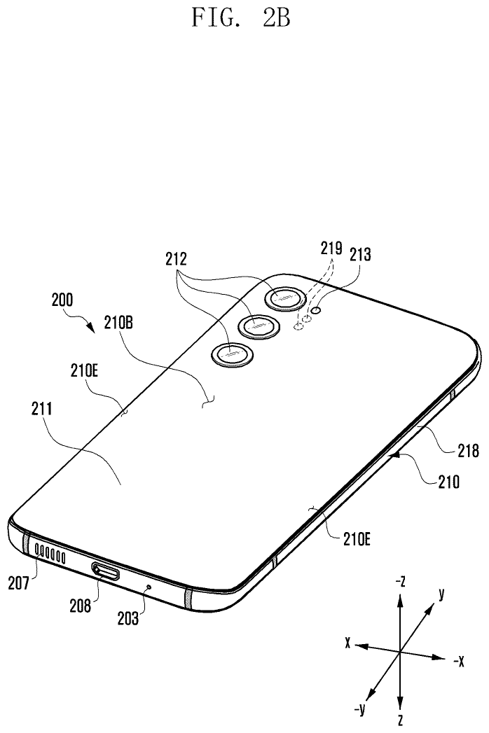

FIG. 2A is a front perspective view of an electronic device 200 according to an embodiment of the disclosure. FIG. 2B is a rear perspective view of a rear surface of the electronic device 200 shown in FIG. 2A according to \an embodiment of the disclosure.

The electronic device 200 in FIGS. 2A and 2B may be at least partially similar to the electronic device 101 in FIG. 1 or may further include other embodiments.

Referring to FIGS. 2A and 2B, the electronic device 200 may include a housing 210 that includes a first surface (or front surface) 210A, a second surface (or rear surface) 210B, and a lateral surface 210C that surrounds a space between the first surface 210A and the second surface 210B. The housing 210 may refer to a structure that forms a part of the first surface 210A, the second surface 210B, and the lateral surface 210C. The first surface 210A may be formed of a front plate 202 (e.g., a glass plate or polymer plate coated with a variety of coating layers) at least a part of which is substantially transparent. The second surface 210B may be formed of a rear plate 211 which is substantially opaque. The rear plate 211 may be formed of, for example, coated or colored glass, ceramic, polymer, metal (e.g., aluminum, stainless steel (STS), or magnesium), or any combination thereof. The lateral surface 210C may be formed of a lateral bezel structure (or “lateral member”) 218 which is combined with the front plate 202 and the rear plate 211 and includes a metal and/or polymer. The rear plate 211 and the lateral bezel structure 218 may be integrally formed and may be of the same material (e.g., a metallic material such as aluminum).

The front plate 202 may include two first regions 210D disposed at long edges thereof, respectively, and bent and extended seamlessly from the first surface 210A toward the rear plate 211. Similarly, the rear plate 211 may include two second regions 210E disposed at long edges thereof, respectively, and bent and extended seamlessly from the second surface 210B toward the front plate 202. The front plate 202 (or the rear plate 211) may include only one of the first regions 210D (or of the second regions 210E). The first regions 210D or the second regions 210E may be omitted in part. When viewed from a lateral side of the electronic device 200, the lateral bezel structure 218 may have a first thickness (or width) on a lateral side where the first region 210D or the second region 210E is not included, and may have a second thickness, being less than the first thickness, on another lateral side where the first region 210D or the second region 210E is included.

The electronic device 200 may include at least one of a display 201, audio modules 203, 207 and 214, sensor modules 204 and 219, camera modules 205, 212 and 213, a key input device 217, a light emitting device, and connector holes 208 and 209. The electronic device 200 may omit at least one (e.g., the key input device 217 or the light emitting device) of the above components, or may further include other components.

The display 201 may be visible through a substantial portion of the front plate 202, for example. At least a part of the display 201 may be visible through the front plate 202 that forms the first surface 210A and the first region 210D of the lateral surface 210C. The display 201 may be combined with, or adjacent to, a touch sensing circuit, a pressure sensor capable of measuring the touch strength (pressure), and/or a digitizer for detecting a stylus pen. At least a part of the sensor modules 204 and 219 and/or at least a part of the key input device 217 may be disposed in the first region 210D and/or the second region 210E.

According to certain embodiments, the input device 203 may include at least one microphone. In certain embodiments, the input device 203 may include a plurality of microphones disposed to detect the direction of a sound. According to an embodiment, the sound output devices may include speakers. According to an embodiment, the input device 203 may include a receiver for calls disposed in the first housing 210, and a speaker. In certain embodiments, the input device 203, the sound output devices, and the connector port 208 may be disposed in a space arranged in the first housing 210 and/or the second housing 220 of the electronic device 200, and may be exposed to the external environment through at least one hole formed in the first housing 210 and/or the second housing 220. In certain embodiments, the sound output devices may include a speaker (e.g., piezo speaker) that operates without using a hole formed in the first housing 210 and/or the second housing 220. In certain embodiments, the electronic device 200 may include a tray member disposed through at least a portion of the lateral bezel structure 218.

The sensor modules 204 and 219 may generate electrical signals or data corresponding to an internal operating state of the electronic device 200 or to an external environmental condition. The sensor modules 204 and 219 may include a first sensor module 204 (e.g., a proximity sensor) and/or a second sensor module (e.g., a fingerprint sensor) disposed on the first surface 210A of the housing 210, and/or a third sensor module 219 (e.g., a heart rate monitor (HRM) sensor) and/or a fourth sensor module (e.g., a fingerprint sensor) disposed on the second surface 210B of the housing 210. The fingerprint sensor may be disposed on the second surface 210B as well as the first surface 210A (e.g., the display 201) of the housing 210. The electronic device 200 may further include at least one of a gesture sensor, a gyro sensor, an air pressure sensor, a magnetic sensor, an acceleration sensor, a grip sensor, a color sensor, an infrared (IR) sensor, a biometric sensor, a temperature sensor, a humidity sensor, or an illuminance sensor 204.

The camera modules 205, 212 and 213 may include a first camera device 205 disposed on the first surface 210A of the electronic device 200, and a second camera device 212 and/or a flash 213 disposed on the second surface 210B. The camera module 205 or the camera module 212 may include one or more lenses, an image sensor, and/or an image signal processor. The flash 213 may include, for example, a light emitting diode or a xenon lamp. Two or more lenses (infrared cameras, wide angle and telephoto lenses) and image sensors may be disposed on one side of the electronic device 200.

The key input device 217 may be disposed on the lateral surface 210C of the housing 210. The electronic device 200 may not include some or all of the key input device 217 described above, and the key input device 217 which is not included may be implemented in another form such as a soft key on the display 201. The key input device 217 may include the sensor module disposed on the second surface 210B of the housing 210.

The indicator may be disposed on the first surface 210A of the housing 210. For example, the indicator may provide status information of the electronic device 200 in an optical form. The indicator may provide a light source associated with the operation of the camera module 205. The indicator may include, for example, a light emitting diode (LED), an IR LED, or a xenon lamp.

The connector hole 208 may include a first connector hole 208 adapted for a connector (e.g., a USB connector) for transmitting and receiving power and/or data to and from an external electronic device, and/or a second connector hole adapted for a connector (e.g., an earphone jack) for transmitting and receiving an audio signal to and from an external electronic device.

Some camera modules 205 of camera modules 205 and 212, some sensor modules 204 of sensor modules 204 and 219, or an indicator may be arranged to be exposed through a display 201. For example, the camera module 205, the sensor module 204, or the indicator may be arranged in the internal space of an electronic device 200 so as to be brought into contact with an external environment through an opening of the display 201, which is perforated up to a front plate 202. According to an embodiment, an area corresponding to some camera module 105 of the display 201 is a part of an area in which content is displayed, and may be formed as a transmission area having designated transmittance. For example, the transmission area may be formed to have transmittance having a range of about 5% to about 20%. The transmission area may include an area overlapped with a valid area (e.g., a field of view (FOV)) of the camera module 105 through which light imaged by an image sensor and for generating an image passes. For example, a transmission area of the display 201 may include an area in which the density of pixels and/or a wiring density are lower than that of surroundings. The camera module 205 may include, for example, under display camera (UDC). In an embodiment, some sensor modules 204 may be arranged to perform their functions without being visually exposed through the front plate 202 in the internal space of the electronic device. For example, in this case, an area of the display 201 facing the sensor module may not require a perforated opening.

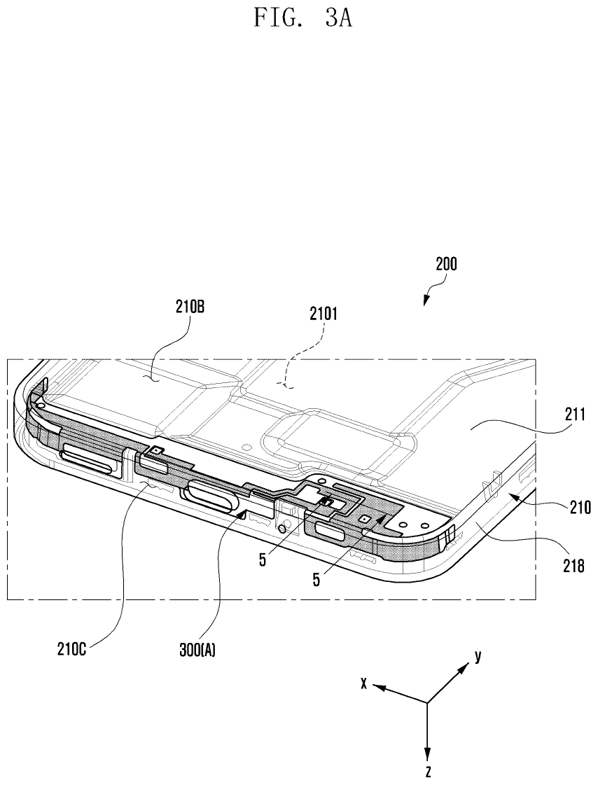

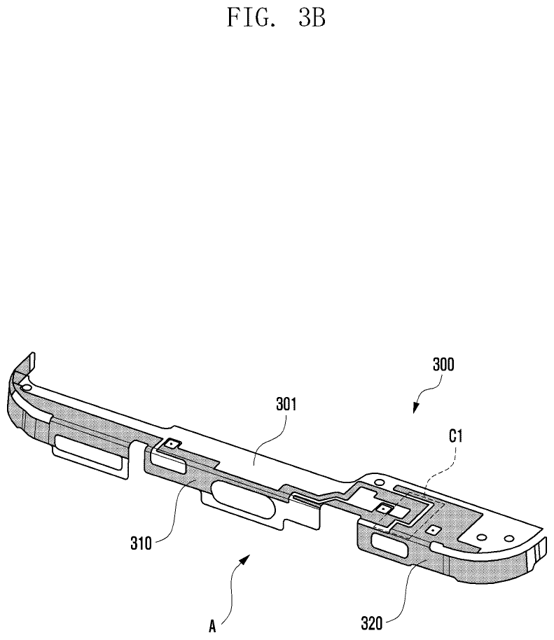

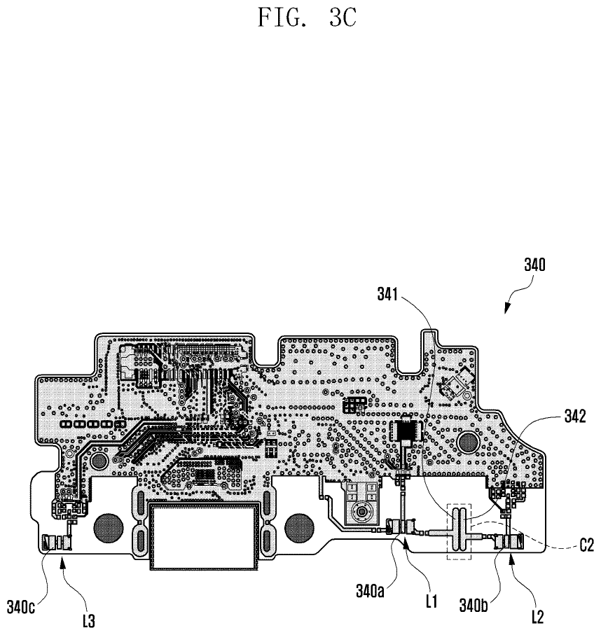

FIG. 3A is a partial perspective view of an electronic device including an antenna structure according to one or more embodiments of the disclosure. FIG. 3B is a perspective view of an antenna structure according to one or more embodiments of the disclosure.

The electronic device 200 of FIG. 3A may be at least partially similar to the electronic device 101 of FIG. 1 or the electronic device 200 of FIG. 2A. The electronic device 200 of FIG. 3A may correspond to other embodiments of the electronic device.

With reference to FIG. 3A and FIG. 3B, the electronic device 200 may include the housing 210 that includes a front cover (e.g., a front plate 202 of FIG. 2A) facing a first direction (e.g., z-axis direction) and a rear cover 211 (e.g., a rear plate 211 of FIG. 2B) facing an opposite direction (e.g., −z-axis direction) to the front cover 202 and a display (e.g., a display 201 of FIG. 2A) between the front cover 202 and the rear cover 211 and visible through the front cover 202. In an embodiment, the rear cover 211 may extend from the rear surface 210B of the electronic device 200 to at least a portion of the side surface 210C. In an embodiment, the electronic device 200 may include an internal space 2101 (or an internal area) through coupling of the rear cover 211 and the front cover 202. In an embodiment, the electronic device 200 may include the lateral member 218 (e.g., lateral bezel structure 218 of FIG. 2A) that forms at least a portion of the side surface 210C. In an embodiment, the lateral member 218 may be formed of a nonconductive material (e.g., polymer). In some embodiments, the lateral member 218 may be formed of a conductive material (e.g., metal). In some embodiments, the lateral member 218 may be formed through coupling of the conductive material and the nonconductive material (e.g., injection or structural coupling).

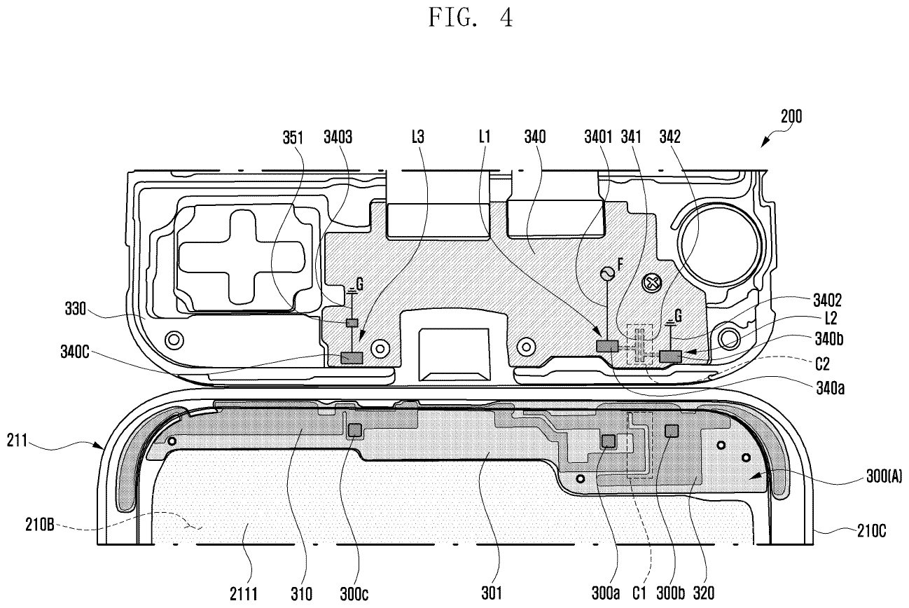

According to one or more embodiments, as shown in FIGS. 3A and 3B, the electronic device 200 may include an antenna structure 300 in the internal space 2101 between the front cover 202 and the rear cover 211. In an embodiment, the antenna structure 300 may include a dielectric substrate 301 and a single pair of radiators 310 and 320 (e.g., conductive patterns or conductive pads) disposed (or coupled or attached) to the dielectric substrate 301. In an embodiment, a single pair of radiators 310 and 320 may include the first radiator 310 and the second radiator 320 that is near the first radiator 310. In an embodiment, the antenna structure 300 may include a first coupling area (C1) (e.g., a first coupling structure) configured to be coupled through close layout of the first radiator 310 and the second radiator 320. In an embodiment, the antenna structure 300 may be attached to the inner surface of the rear cover 211 (e.g., inner surface 2111 of FIG. 4) through the dielectric substrate 301. In an embodiment, at least a portion of the antenna structure 300 may be extended from the inner surface 2111 of the rear cover 211 to the inner surface of the side surface 210C of the electronic device 200 through the dielectric substrate 301. In some embodiments, in the antenna structure 300, the dielectric substrate 301 may be omitted, and the first radiator 310 and the second radiator 320 may be directly on the inner surface 2111 of the rear cover 211 and/or the inner surface of the side surface. In some embodiments, the antenna structure 300 may refer to the first and second radiators 310 and 320, and may be replaced with a flexible printed circuit board (FPCB) that includes a conductive pattern and/or a conductive pad.

According to one or more embodiments, the antenna structure 300 may operate as a single feed multiband antenna (A) using the first radiator 310 and the second radiator 320. In an embodiment, the antenna (A) may be configured to transmit and/or receive wireless signals in a plurality of different frequency bands. In an embodiment, the plurality of frequency bands may include the first frequency band (hereinafter, ‘low band’) within the range of 600 MHz to 960 MHz that operates through the first radiator 310 electrically connected to the wireless communication circuitry, the second frequency band (hereinafter, ‘mid band’) within the range of 1700 MHz to 2200 MHz that operates through the second radiator 320 coupled to the first radiator 310 through the first coupling area (C1), the third frequency band (hereinafter, ‘high band’) within the range of 2300 MHz to 2800 MHz, and/or the fourth frequency band (hereinafter, ‘6G band’) within the range of about 7 GHz to 8 GHz.

FIG. 3C is a configuration diagram of a substrate according to one or more embodiments of the disclosure.

With reference to FIG. 3C, an electronic device (e.g., electronic device 200 of FIG. 3A) may include a substrate 340 between the antenna structure 300 and a display (e.g., display 201 of FIG. 2A) in internal space (e.g., internal space 2101 of FIG. 3A). In an embodiment, the antenna structure 300 may be, at least partially, between the rear cover 211 and the substrate 340. In an embodiment, when the substrate 340 is viewed from above (e.g., when rear surface 211 of electronic device 200 is viewed from above), the antenna structure 300 may at least partially overlap the substrate 340. In an embodiment, the substrate 340 may include ground (e.g., ground (G) of FIG. 4) (e.g., ground plane). In an embodiment, wireless communication circuitry (e.g., the wireless communication circuitry (F) of FIG. 4) (e.g., the wireless communication module 192 of FIG. 1) may be disposed to the substrate 340.

According to one or more embodiments, the substrate 340 may include a first point (L1) electrically connected to the wireless communication circuitry (F) and a second point (L2) electrically connected to the ground (G) and spaced apart from the first point (L1). In an embodiment, the first point (L1) may be electrically connected to the first radiator 310 through a first conductive contact 340a. In an embodiment, the second point (L2) may be electrically connected to the second radiator 320 through a second conductive contact 340b. In some embodiments, the first point (L1) and second point (L2) of the substrate 340 may be directly connected to the first antenna radiator 310 and the second antenna radiator 320, respectively, without the first conductive contact 340a and the second conductive contact 340b. In an embodiment, the substrate 340 may include a third point (L3) that is positioned at a further distance from the second point (L2) than the first point (L1) and electrically connected to the ground (G) of the substrate 340. In an embodiment, the third point (L3) may be connected to the first radiator 310 through a third conductive contact 340c. In some embodiments, the third point (L3) of the substrate 340 may be electrically connected directly to the first antenna radiator 310 without the third conductive contact 340c.

According to one or more embodiments, the substrate 340 may include a first conductive pad 341 (e.g., first conductive pattern) electrically connected to the first point (L1) and a second conductive pad 342 (e.g., second conductive pattern) electrically connected to the second point (L2). In an embodiment, the first conductive pad 341 and the second conductive pad 342 may include a second coupling area (C2) (e.g., second coupling structure) configured through close layout. In an embodiment, the first conductive pad 341 and the second conductive pad 342 may be at least a portion of wiring (e.g., conductive trace or conductive pattern) formed on the substrate 340.

According to an example embodiment of the disclosure, when the antenna structure 300 and the substrate 340 are in the internal space 2101 of the electronic device 200, the first coupling area (C1) of the antenna structure 300 and the second coupling area (C2) of the substrate 340 may at least partially overlap. For example, when the substrate 340 is viewed from above, the coupling layout of the first radiator 310 and the second radiator 320 may increase through overlapping layout of the first coupling area (C1) and the second coupling area (C2) and, through this, the radiation performance of the antenna (A) may be improved (e.g., increase in gain and bandwidth expansion).

FIG. 4 is a partially expanded view of an electronic device including a substrate and an antenna structure according to one or more embodiments of the disclosure.

In describing the antenna structure 300 and the substrate 340 of FIG. 4 the same reference numerals are assigned to components that are substantially the same as the antenna structure 300 of FIG. 3B and the substrate 340 of FIG. 3C, and the detailed description related thereto may be omitted.

FIG. 4 is a view illustrating a state in which a support member 330 (e.g., support body) that supports the substrate 340 and the rear cover 211 are unfolded before the electronic device 200 is assembled. If the electronic device 200 is assembled, the visible surface of the illustrated substrate 340 may be positioned to face the inner surface 2111 of the rear cover 211 and the antenna structure 300.

With reference to FIG. 4, the electronic device 200 may include the rear cover 211 and the support member 330 (e.g., support body, support structure, or bracket) that couples with the rear cover 211. In an embodiment, the electronic device 200 may include the antenna structure 300 on the inner surface 2111 of the rear cover 211 and the substrate 340 supported by the support member 330. In an embodiment, the support member 330 may be configured to support the display (e.g., display 201 of FIG. 2A) and/or the front cover (e.g., front cover 202 of FIG. 2A). In an embodiment, when the support member 330 couples with the rear cover 211, at least a portion of the substrate 340 and the antenna structure 300 may be at a location at which they face each other and at least partially overlap.

According to one or more embodiments, the substrate 340 may include the first point (L1) electrically connected to the wireless communication circuitry (F) (e.g., wireless communication module 192 of FIG. 1) through a first electrical path 3401 (e.g., first wire or first trace), the second point (L2) electrically connected to the ground (G) through a second electrical path 3402 (e.g., second wire or second trace) and spaced apart from the first point (L1), and/or the third point (L3) electrically connected to the ground (G) through a third electrical path 3403 (e.g., third wire or third trace). In an embodiment, the substrate 340 may include at least one first passive element 351 having a specific element value, in the third electrical path 3403. In an embodiment, the at least one first passive element 351 may include an inductor or a capacitor.

According to one or more embodiments, the antenna structure 300 may include the dielectric substrate 301, the first radiator 310 disposed to the dielectric substrate 301, and the second radiator 320 that is spaced apart from the first radiator 310. In an embodiment, the antenna structure 300 may include the first coupling area (C1) (e.g., first coupling structure) configured through close layout of the first radiator 310 and the second radiator 320. In an embodiment, the antenna structure 300 may include a first contact pad 300a in which a portion of the first radiator 310 is exposed to the outside or electrically connected to the first radiator 310 at a location corresponding to the first point (L1) of the substrate 340, a second contact pad 300b in which a portion of the second radiator 320 is exposed to the outside or electrically connected to the second radiator 320 at a location corresponding to the second point (L2) of the substrate 340, and/or a third contact pad 300c in which a portion of the first radiator 310 is exposed to the outside or electrically connected to the first radiator 310 at a location corresponding to the third point (L3) of the substrate 340.

According to one or more embodiments, the substrate 340 may include the first conductive pad 341 electrically connected to the first point (L1) and the second conductive pad 342 electrically connected to the second point (L2). In an embodiment, the substrate 340 may include the second coupling area (C2) (e.g., second coupling structure) configured through close layout of the first conductive pad 341 and the second conductive pad 342. In an embodiment, the first electrical path 3401, the second electrical path 3402, the third electrical path 3403, the first conductive pad 341, and the second conductive pad 342 may be conductive traces formed on the substrate 340.

According to one or more embodiments, the substrate 340 may include the first conductive contact 340a at the first point (L1), the second conductive contact 340b at the second point (L2), and/or the third conductive contact 340c at the third point (L3). In an embodiment, each of the first, second, and third conductive contacts 340a, 340b, and 340c may include at least one of a C-clip, a pogo pin, or a conductive tape.

According to one or more embodiments, when the support member 330 couples with the rear cover 211, the first, second, and third conductive contacts 340a, 340b, and 340c of the substrate 340 may elastically contact the first, second, and third contact pads 300a, 300b, and 300c of the antenna structure 300, respectively, and the antenna structure 300 may be electrically connected to the substrate 340. In this case, when the substrate 340 is viewed from above, the first coupling area (C1) and the second coupling area (C2) may at least partially overlap. For example, the overlap amount between the first coupling area (C1) and the second coupling area (C2) may be configured to have the overlap amount that exceeds about 50% of the total overlap amount (e.g., when first coupling area (C1) and second coupling area (C2) completely overlap).

According to an example embodiment of the disclosure, when the electronic device 200 is assembled, at least a portion of the antenna structure 300 and at least a portion of the substrate 340 may be electrically connected and may face each other. The first coupling area (C1) of the antenna structure 300 and the second coupling area (C2) of the substrate 340 may at least partially overlap. For example, when the substrate 340 is viewed from above, the coupling amount between the first radiator 310 and the second radiator 320 may increase through overlapping layout of the first coupling area (C1) and the second coupling area (C2) and, through this, the radiation performance of the antenna (A) may be improved (e.g., increase in gain and bandwidth expansion) in a specific frequency band (e.g., mid band and/or high band).

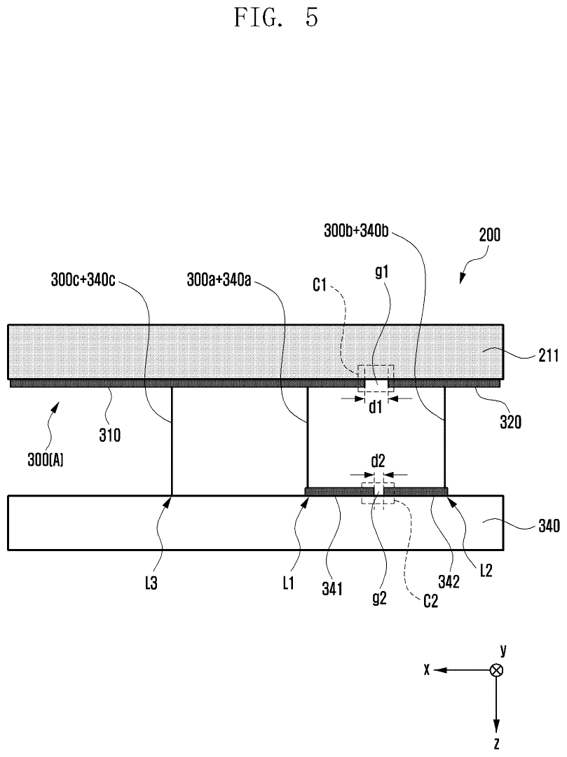

FIG. 5 illustrates a layout structure of a substrate and an antenna structure viewed along line 5-5 of FIG. 3A according to one or more embodiments of the disclosure.

With reference to FIG. 5, the antenna structure 300 may be electrically connected to the substrate 340 in such a manner that the first, second, and third conductive contacts 340a, 340b, and 340c of the substrate 340 elastically contact the first, second, and third contact pads 300a, 300b, and 300c of the antenna structure 300, respectively. In an embodiment, the antenna structure 300 may include the first coupling area (C1) in which the first radiator 310 and the second radiator 320 are spaced apart from each other to have a first distance (d1). In an embodiment, the substrate 340 may include the second coupling area (C2) in which the first conductive pad 341 and the second conductive pad 342 are spaced apart from each other to have a second distance (d2). In an embodiment, when the substrate 340 is viewed from above, the second distance (d2) may be formed to be less than the first distance (d1). For example, when the first radiator 310 and the second radiator 320 of the antenna structure 300 are formed through a mechanical process such as a punching process, there may be a limit in reducing the first distance (d1). On the other hand, the first conductive pad 341 and the second conductive pad 342 formed on the substrate 340 are formed in a patterning manner on the substrate 340 and thus, are formed to have the second distance (d2) less than the first distance (d1), thereby helping increase the coupling amount for the first radiator 310 and the second radiator 320. In some embodiments, within the range in which coupling occurs, the second distance (d2) may be configured to be equal to the first distance (d1) or greater than the first distance (d1).

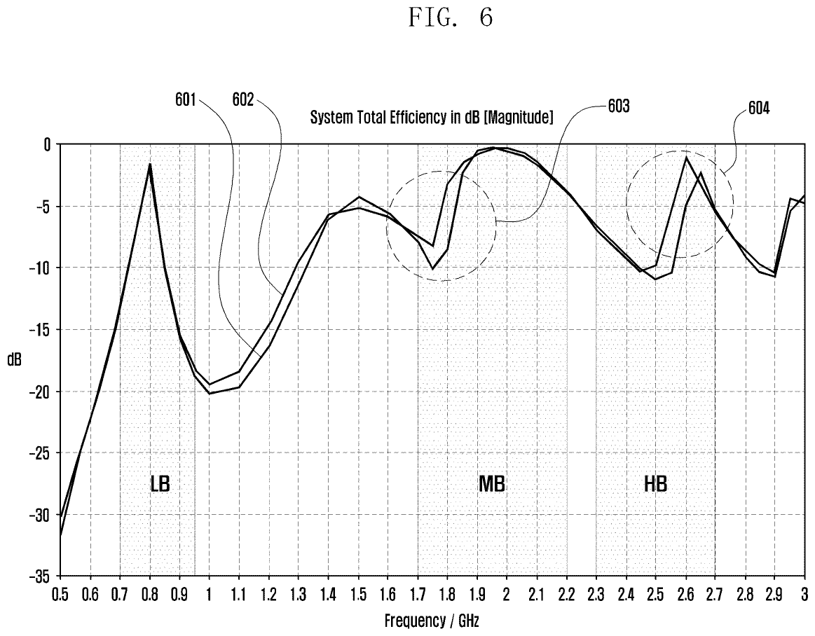

FIG. 6 is a graph comparing the radiation performance of the antenna of FIG. 4 depending on whether a second coupling area is provided according to one or more embodiments of the disclosure.

With reference to FIG. 6, compared to a case in which the second coupling area (C2) formed through the first and second conductive pads 341 and 342 of the substrate 340 is absent and the antenna (A) operates using only the first coupling area (C1) formed through the first and second radiators 310 and 320 (e.g., graph 601), when the antenna (A) operates using the first coupling area (C1) and the second coupling area (C2) to overlap the first coupling area (C1) (e.g., graph 602), the antenna (A) exhibits relatively superior radiation performance in the mid band (e.g., area 603) and/or high band (e.g., area 604). This may indicate that the antenna (A) operating through coupling feed of the first radiator 310 and the second radiator 320 has the improved radiation performance if the coupling amount increases in the corresponding frequency band (e.g., mid band and high band).

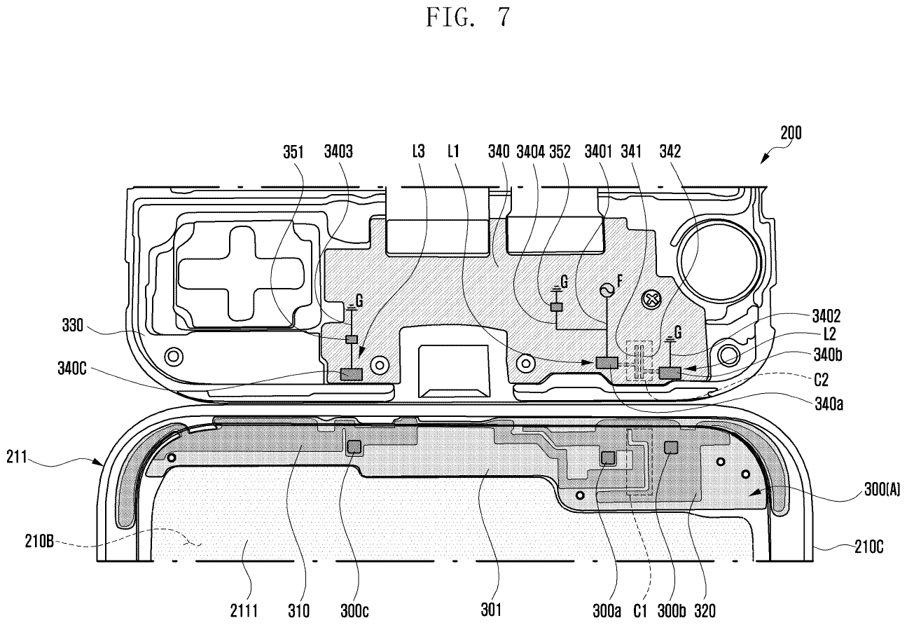

FIG. 7 is a partially expanded view of an electronic device including a substrate and an antenna structure according to one or more embodiments of the disclosure.

In describing the electronic device 200 of FIG. 7, the same reference numerals are assigned to components that are substantially the same as the electronic device 200 of FIG. 4, and detailed description related thereto may be omitted.

With reference to FIG. 7, the substrate 340 may include at least one second passive element 352 in a fourth electrical path 3404 branched from the first electrical path 3401 and electrically connected to the ground (G) of the substrate 340. In an embodiment, the at least one second passive element 352 may include an inductor and/or a capacitor having a specific element value.

According to one or more embodiments, the antenna (A) may have an improved radiation function or its operating frequency band shifted through the at least one first passive element 351 in the third electrical path 3403 and the at least one second passive element 352 in the fourth electrical path 3404.

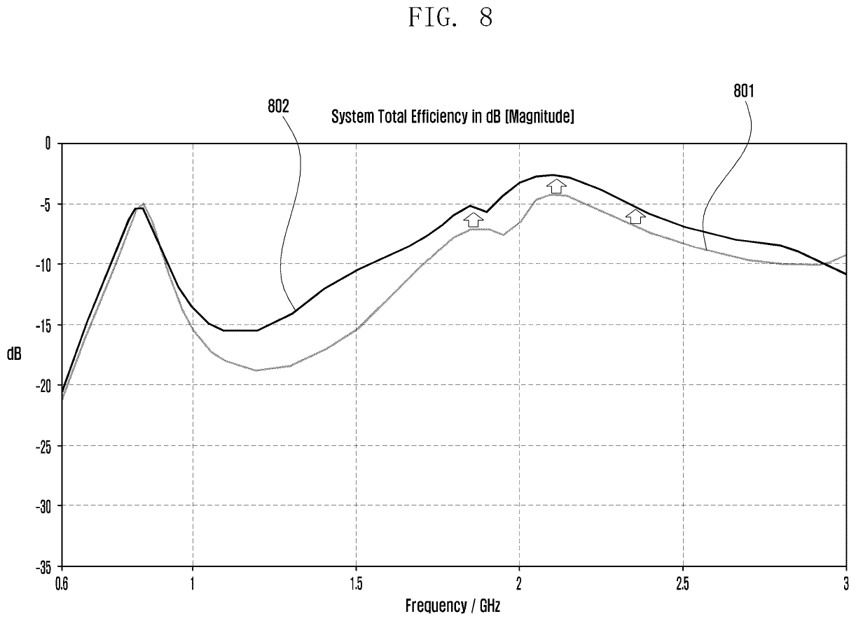

FIG. 8 is a graph comparing the radiation performance of the antenna of FIG. 7 depending on whether a second coupling area is provided according to one or more embodiments of the disclosure.

With reference to FIG. 8, in a state in which the first passive element 351 is applied as an inductor having an inductance value of about 3.9 nH and the second passive element 352 is applied as an inductor having an inductance value of about 8.2 nH, compared to a case in which the second coupling area (C2) formed through the first and second conductive pads 341 and 342 of the substrate 340 is absent and the antenna (A) operates using only the first coupling area (C1) formed through the first and second radiators 310 and 320 (e.g., graph 801), when the antenna (A) operates using the first coupling area (C1) and the second coupling area (C2) that overlaps the first coupling area (C1) (e.g., graph 802), the antenna (A) exhibits relatively superior radiation performance in the mid band and/or high band.

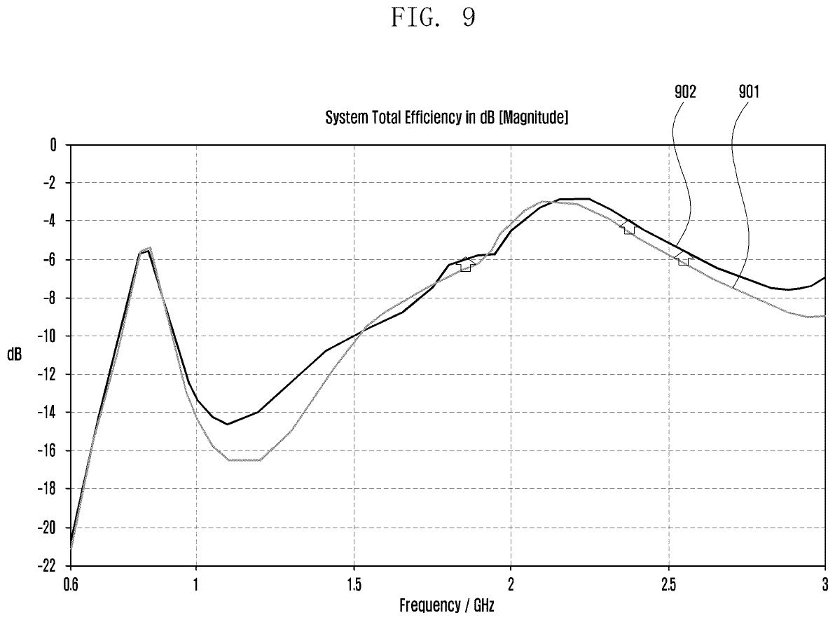

FIG. 9 is a graph comparing the radiation performance of the antenna of FIG. 7 depending on whether overlapping between a first coupling area and a second coupling area is present according to one or more embodiments of the disclosure.

With reference to FIG. 9, compared to a case in which the first coupling area (C1) formed through the first and second radiators 310 and 320 does not overlap the second coupling area (C2) formed through the first and second conductive pads 341 and 342 of the substrate 340 (e.g., graph 901), when the first coupling area (C1) and the second coupling area (C2) overlap, the antenna (A) exhibits relatively superior radiation performance in the mid band and/or high band.

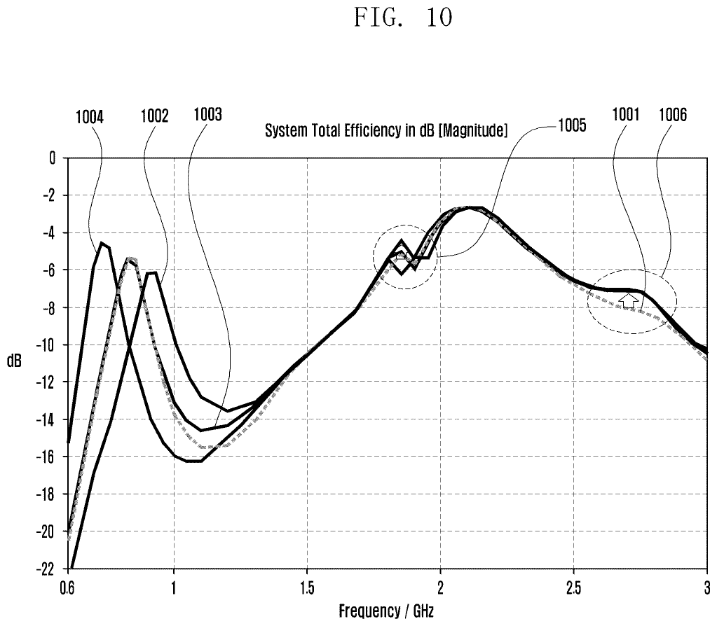

FIG. 10 is a graph showing the radiation performance of the antenna FIG. 7 according to an increase in the coupling amount of a second coupling area according to one or more embodiments of the disclosure.

With reference to FIG. 10, although the second passive element 352 is fixed to an inductor having an inductance value of about 8.2 nH and the first passive element 351 is changed to an inductor having inductance values of about 1 nH (e.g., graph 1002), 3.9 nH (e.g., graph 1003) and 10 nH (e.g., graph 1004), in the case of increasing the coupling amount of the second coupling area (C2) by increasing the length of the first and second conductive pads 341 and 342, the antenna (A) exhibits relatively excellent radiation performance in the mid band and/or high band (e.g., area 1005 and area 1006) compared to a case before increasing the length of the first and second conductive pads 341 and 342 (e.g., graph 1001). This may indicate the radiation performance and/or the operating frequency band of the antenna (A) may be determined based on the coupling amount of the second coupling area (C2) formed through close layout of the first conductive pad 341 and the second conductive pad 342.

According to one or more embodiments, the antenna (A) may have its operating frequency band in the low band through an element value of the first passive element 351. Then, by adjusting the coupling amount of the first and second conductive pads 341 and 342, its operating frequency band in the mid band and/or high band may be determined.

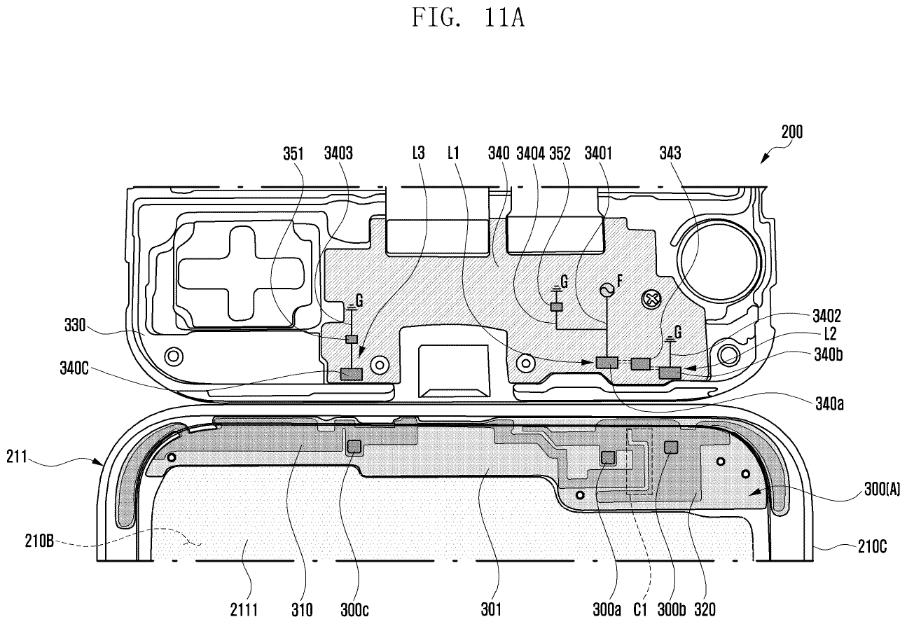

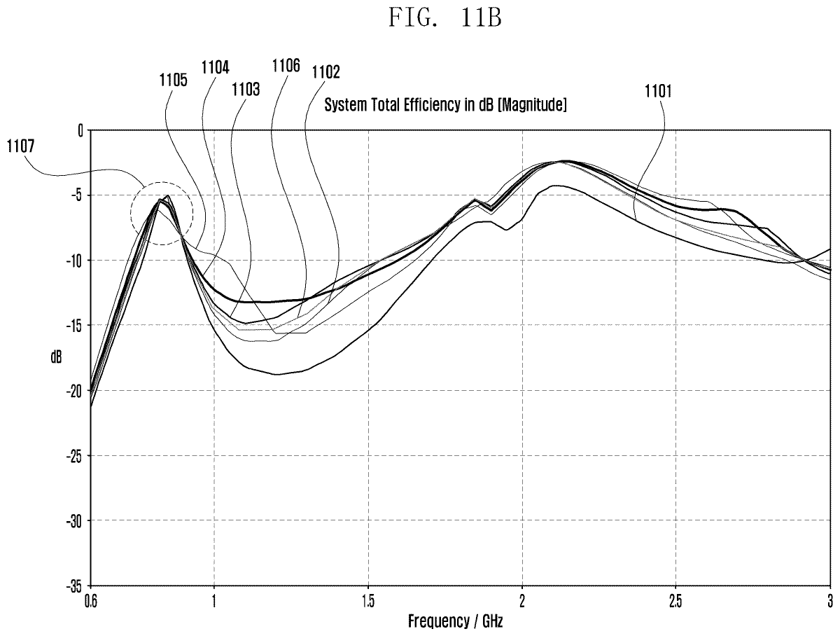

FIG. 11A is a partially expanded view of an electronic device including a substrate and an antenna structure according to one or more embodiments of the disclosure.

In describing the electronic device 200 of FIG. 11A, the same reference numerals are assigned to components that are substantially the same as the electronic device 200 of FIG. 7, and detailed description related thereto may be omitted.

With reference to FIG. 11A, the second coupling area (C2) using the first and second conductive pads 341 and 342 of the substrate 340 to overlap the first coupling area (C1) of the antenna structure 300 may be replaced with a capacitor 343, which has a specific capacitance value, in an electrical path that connects the first point (L1) and the second point (L2) of the substrate 340. In this case, when the substrate 340 is viewed from above, the capacitor 343 may be at a location that at least partially overlaps the first coupling area (C1) of the antenna structure 300.

FIG. 11B is a graph comparing the radiation performance of the antenna of FIG. 11A according to a change in a capacitance value of a capacitor according to one or more embodiments of the disclosure.

With reference to FIG. 11B, in a state in which the first passive element 351 is fixed to an inductor having an inductance value of about 3.9 nH (e.g., graph 1106) and the second passive element 352 is fixed to an inductor having an inductance value of about 8.2 nH, in the case of sequentially changing the capacitance value of the capacitor 343 to about 0.5 pF (e.g., graph 1102), 0.75 pF (e.g., graph 1103), 1 pF (e.g., graph 1104), and 1.2 pF (e.g., graph 1105), the antenna (A) exhibits the overall superior radiation performance compared to a case in which the capacitor 343 is not provided (e.g., graph 1101), and in at least some cases, t the antenna (A) exhibits the radiation performance equivalent to one achieved in the case of using the second coupling area (C2) using the first and second conductive pads 341 and 342 (e.g., graph 1106). For example, when the capacitance value of the capacitor 343 is about 1.2 pF, the radiation performance decreases in the low band (e.g., area 1107).

This may represent that, although the second coupling area (C2), which overlaps the first coupling area (C1) of the antenna structure 300, is replaced with the capacitor 343, the radiation performance of the antenna (A) is improved if the capacitor 343 having a capacitance value within appropriate range (e.g., range of about 0.5 pF to 0.75 pF) is applied.

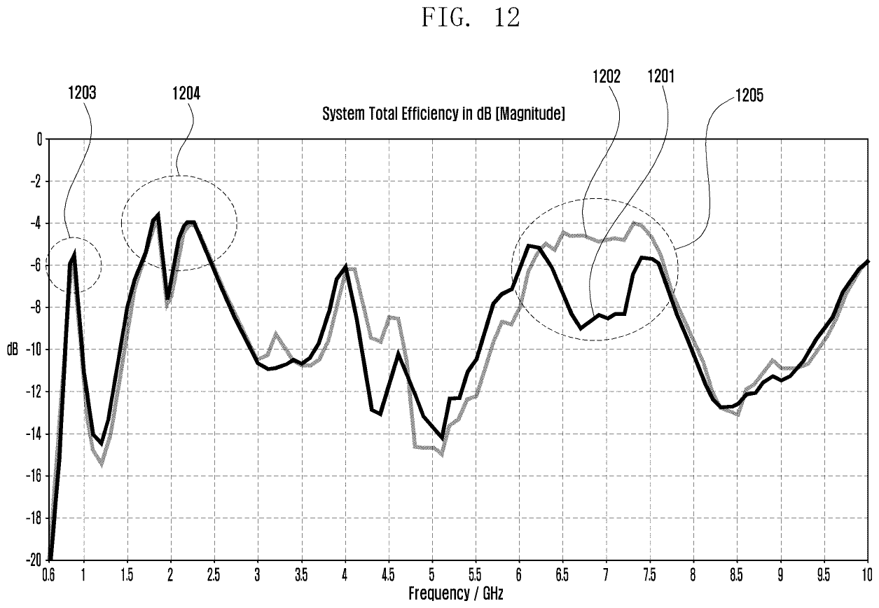

FIG. 12 is a graph comparing the radiation performance of the antenna of FIG. 4 depending on whether a second coupling area is provided according to one or more embodiments of the disclosure.

With reference to FIG. 12, compared to a case of operating using only the first coupling area (C1) formed through the first and second radiators 310 and 320 with absence of the second coupling area (C2) formed through the first and second conductive pads 341 and 342 of the substrate 340 (e.g., graph 1201), in the case of operating using the first coupling area (C1) and the second coupling area (C2) that overlaps the first coupling area (C1) (e.g., graph 1202), the antenna (A) exhibits the equivalent or relatively superior radiation performance in the low band (e.g., area 1203), the mid band/high band (e.g., area 1204) and/or the 6G band (e.g., area 1205). This may indicate that the antenna (A) operating through coupling feed of the first radiator 310 and the second radiator 320 may have the improved radiation performance if the coupling amount increases in the corresponding frequency band (e.g., low band, mid band, high band and/or 6G band).

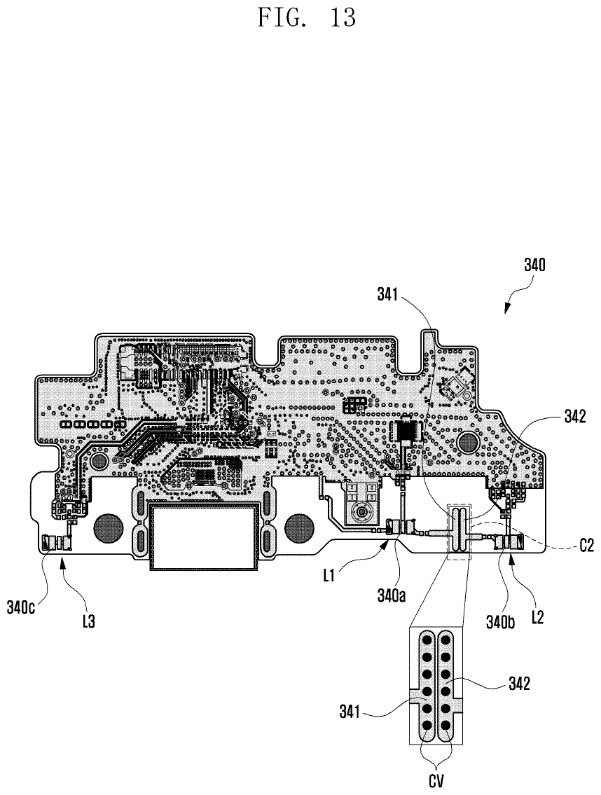

FIG. 13 is a diagram of a substrate according to one or more embodiments of the disclosure.

In describing the substrate 340 of FIG. 13, the same reference numerals are assigned to components that are substantially the same as the substrate 340 of FIG. 3C, and detailed description related thereto may be omitted.

With reference to FIG. 13, the substrate 340 may include the first conductive pad 341 electrically connected to the first point (L1) and the second conductive pad 342 electrically connected to the second point (L2). In an embodiment, the substrate 340 may include the second coupling area (C2) formed through close layout of the first conductive pad 341 and the second conductive pad 342. In an embodiment, the second coupling area (C2) may overlap the first coupling area (e.g., first coupling area (C1) of FIG. 3B) formed through close layout of the first and second radiators (e.g., first radiator 310 and second radiator 320 of FIG. 3B) of the antenna structure (e.g., antenna structure 300 of FIG. 3B) electrically connected to the substrate 340.

According to one or more embodiments, the first conductive pad 341 and/or the second conductive pad 342 may be electrically connected to a conductive layer at least one layer other than the first conductive pad 341 and/or may be electrically connected to the second conductive pad 342 in the substrate 340 stacked with a plurality of layers, through a conductive via (CV), which form a conductive wall. Thus, this structure of the conductive wall may help increasing the coupling amount of the second coupling area (C2). In an embodiment, the coupling amount of the second coupling area (C2) may be determined based on at least one of the shape, the size, and the number of conductive layers at each of the plurality of layers of the substrate 340. In an embodiment, since the arrangement of the second coupling area (C2) using at least one conductive layer electrically connected through the conductive via (CV) may induce an increase in the coupling amount without expanding the first conductive pad 341 and/or the second conductive pad 342 (e.g., increasing area), it is possible to increase the peripheral device layout efficiency of substrate 340 and to help slimness of the electronic device 200.

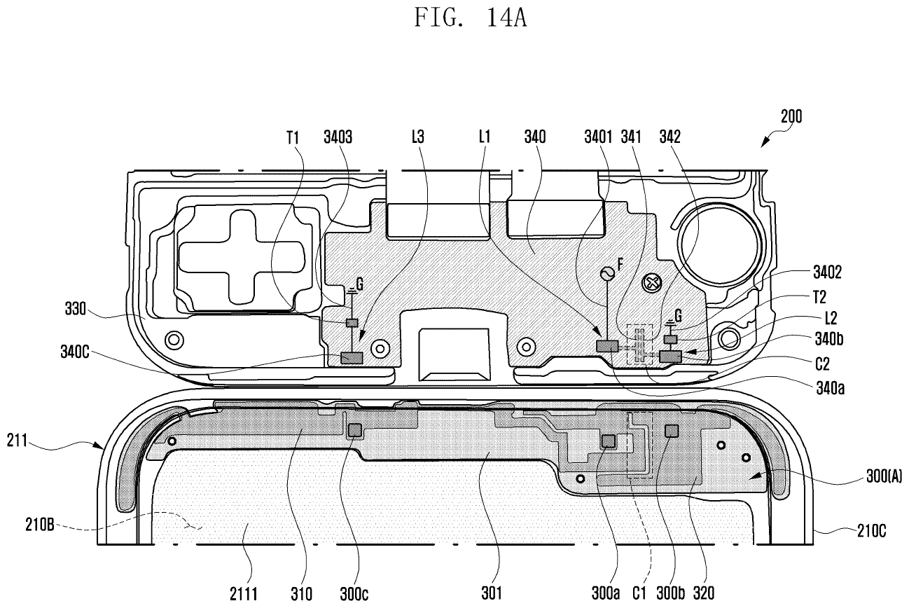

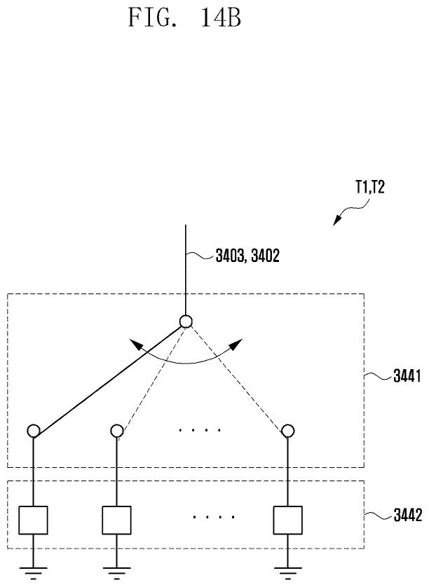

FIG. 14A is a partially expanded view of an electronic device including a substrate and an antenna structure according to one or more embodiments of the disclosure. FIG. 14B is a configuration diagram of a variable circuit of FIG. 14A according to one or more embodiments of the disclosure.

In describing the electronic device 200 of FIG. 14A, the same reference numerals are assigned to components that are substantially the same as the electronic device 200 of FIG. 4, and detailed description related thereto may be omitted.

With reference to FIG. 14A and FIG. 14B, the substrate 340 may include a first variable circuit (T1) in the third electrical path 3403 that connects the third point (L3) and the ground (G) and/or a second variable circuit (T2) in the second electrical path 3402 that connects the second point (L2) and the ground (G). In an embodiment, the operating frequency band of the antenna (A) may be shifted to a specific frequency band through control of the first variable circuit (T1) and/or the second variable circuit (T2) based on state information of the electronic device 200. For example, the operating frequency band of the antenna (A) may be shifted to the specific frequency band through control of the first variable circuit (T1) and/or the second variable circuit (T2) based on grip information of the electronic device 200.

According to one or more embodiments, the first variable circuit (T1) and/or the second variable circuit (T2) may include a switch (e.g., switching circuit) 3441 controlled by a processor (e.g., processor 120 of FIG. 1) of the electronic device 200 and a plurality of passive elements 3442 that connect the third electrical path 3403 and/or the second electrical path 3402 to the ground (G) according to a switching operation of the switch 3441. For example, any one passive element among the plurality of passive elements 3442 may be configured to be in the third electrical path 3403 and/or the second electrical path 3402 through the switching operation of the switch 3441. In an embodiment, the third electrical path 3403 and/or the second electrical path 3402 may be configured such that the ground (G) of the substrate 340 and the third point (L3) and/or the second point (L2) may be electrically connected without connection of the plurality of passive elements 3442 through the switching operation of the switch 3441. In an embodiment, the plurality of passive elements 3442 may include inductors having different inductance values and/or capacitors having different capacitance values.

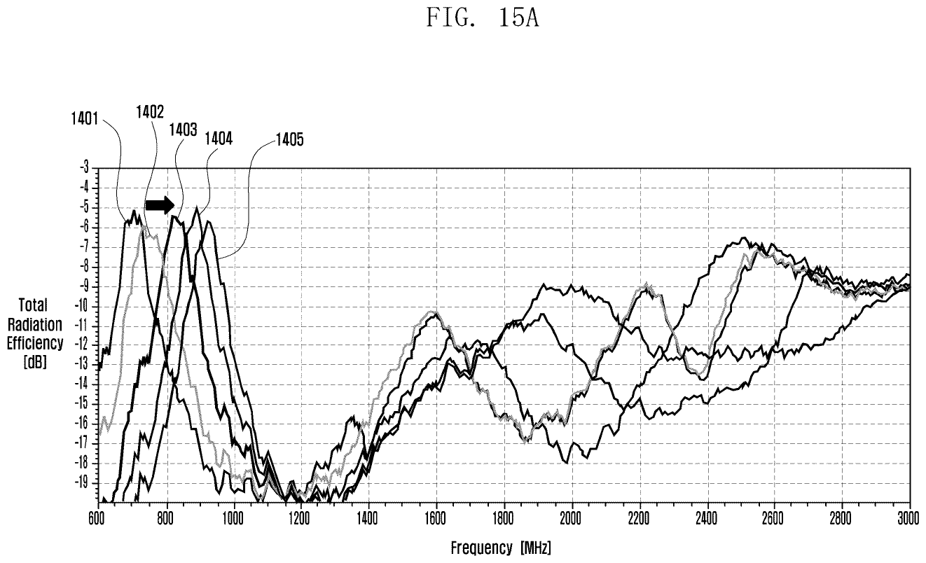

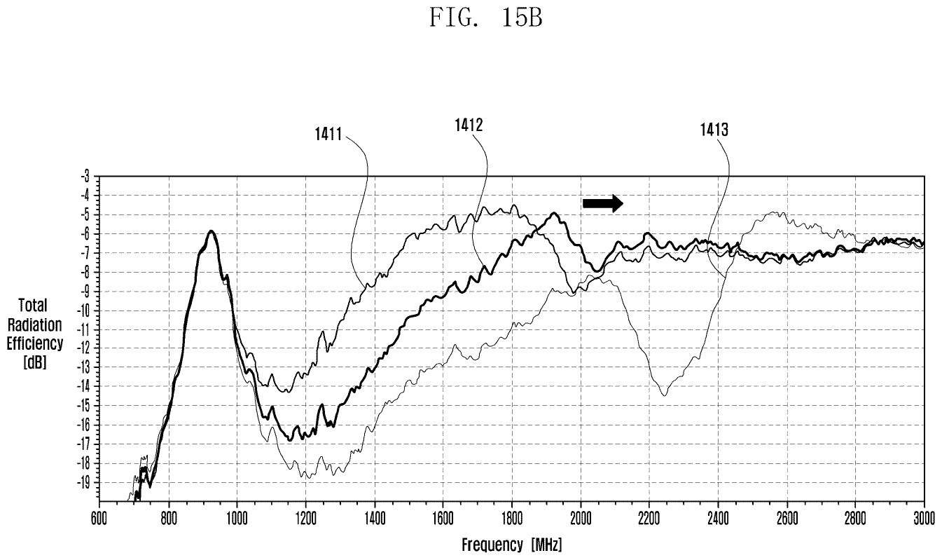

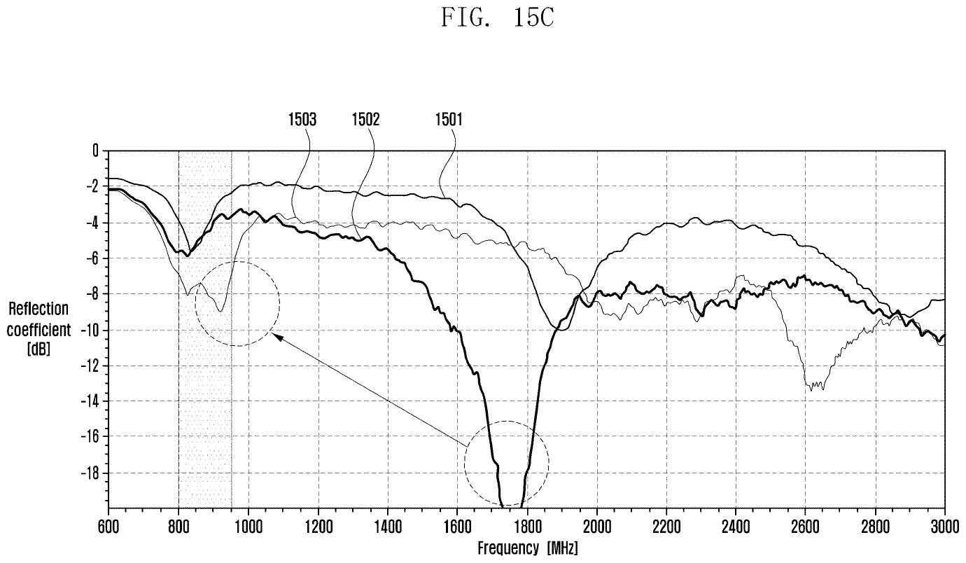

FIG. 15A is a graph comparing the radiation performance of the antenna of FIG. 14A through control of a first variable circuit according to one or more embodiments of the disclosure.

With reference to FIG. 15A, the antenna (A) may be configured such that the frequency band of the low band may be adjusted through control of the first variable circuit (T1). For example, high-shift is performed based on the operating frequency band of the antenna (A) (e.g., graph 1401) in a case in which inductance is not provided, according to a sequential decrease in an inductance value of an inductor to about 8.2 nH (e.g., graph 1402), about 3.9 nH (e.g., graph 1403), about 2 nH (e.g., about 1404), and about 1 nH (e.g., graph 1405) through switch control of the first variable circuit (T1) in the low band. This may indicate that the antenna (A) according to an example embodiment of the disclosure may easily perform frequency design in the low band by switching to an inductor having a specific inductance value through control of the first variable circuit (T1).

FIG. 15B is a graph comparing the radiation performance of the antenna of FIG. 14A through control of a second variable circuit according to one or more embodiments of the disclosure.

With reference to FIG. 15B, the antenna (A) may be configured such that the frequency band of the mid band and/or high band may be adjusted through control of the second variable circuit (T2). For example, the operating frequency band of the antenna (A) is high-shifted without changing the low band frequency according to a sequential decrease in a capacitance value of a capacitor to about 201 pF (e.g., graph 1411), about 5.7 pF (e.g., graph 1412), and about 1 pF (e.g., graph 1413) through switch control of the second variable circuit (T2) in the mid band and/or high band. This may indicate that the antenna (A) according to an example embodiment of the disclosure may easily perform frequency design in the mid band and/or high band by switching to a capacitor having a specific capacitance value under control of the second variable circuit (T2).

FIG. 15C is a graph comparing the radiation performance of an antenna through control of a variable circuit according to griping of an electronic device according to one or more embodiments of the disclosure.

With reference to FIG. 15C, to reduce a degradation in the radiation performance according to griping of the electronic device 200, the antenna (A) may be configured such that the frequency band of the mid band may be adjusted through control of the second variable circuit (T2). For example, the antenna (A) operates in the low band, the mid band, and the high band when the antenna (A) operates in free space without griping (e.g., graph 1501) and when a capacitance value of a capacitor is set to about 100 pF through control of the second variable circuit (T2) (e.g., graph 1502) (e.g., inverted F antenna (IFA)). In an embodiment, when the electronic device 200 is griped by the user, the frequency band corresponding to the low band in the operating frequency band of the antenna (A) may be degraded. To enhance this problem, the capacitor may be changed to an inductor having an inductance value of about 3.9 nH through control of the second variable circuit (T2), and resonance of the mid band may be low-shifted to the low band, which may help improve the perceived performance of the antenna in the low band (dual resonator antenna (DRA)).

According to one or more embodiments, an electronic device may include a housing (e.g., housing 210 of FIG. 3), a substrate (e.g., substrate 340 of FIG. 4) including wireless communication circuitry (e.g., wireless communication circuitry (F) of FIG. 4) and ground (e.g., ground (G) of FIG. 4), and an antenna structure (e.g., antenna structure 300 of FIG. 4) that at least partially overlaps the substrate when the substrate is viewed from above, wherein the antenna structure may include a first radiator (e.g., first radiator 310 of FIG. 4) electrically connected to the wireless communication circuitry through a first point (e.g., first point (L1) of FIG. 4) of the substrate and a second radiator (e.g., second radiator 320 of FIG. 4) electrically connected to the ground through a second point (e.g., second point (L2) of FIG. 4) of the substrate, the first radiator and the second radiator may at least partially form a first coupling area (e.g., first coupling area (C1) of FIG. 4), the substrate may include a first conductive pad (e.g., first conductive pad 341 of FIG. 4) electrically connected to the first point and a second conductive pad (e.g., second conductive pad 342 of FIG. 4) electrically connected to the second point. The first conductive pad and the second conductive pad may be configured to at least partially form a second coupling area (e.g., second coupling area (C2) of FIG. 4). When the substrate is viewed from above, the first coupling area and the second coupling area may be configured to at least partially overlap, and the wireless communication circuitry may be configured to transmit and/or receive wireless signals in a plurality of frequency bands through the first radiator and the second radiator.

According to one or more embodiments, at least one frequency band among the plurality of frequency bands may be determined based on the coupling amount of the second coupling area.

According to one or more embodiments, in the first coupling area, the first radiator and the second radiator may have a first distance (e.g., first distance (d1) of FIG. 5) and, in the second coupling area, the first conductive pad and the second conductive pad may be configured to have a second distance (e.g., second distance (d2) of FIG. 5) less than the first distance.

According to one or more embodiments, the overlap amount between the first coupling area and the second coupling area may be configured to have the overlap amount that exceeds 50% of the total overlap amount.

According to one or more embodiments, the first point may be electrically connected to the wireless communication circuitry through a first electrical path (e.g., first electrical path 3401 of FIG. 4) at the substrate, and the second point may be electrically connected to the ground through a second electrical path (e.g., second electrical path 3402 of FIG. 4) at the substrate.

According to one or more embodiments, the first radiator may be electrically connected to a third point (e.g., third point (L3) of FIG. 4) of the substrate that is further than the first point from the second point, and the substrate may include a at least one first passive element (e.g., first passive element 351 of FIG. 4) in a third electrical path (e.g., third electrical path 3403 of FIG. 4) that electrically connects the third point and the ground.

According to one or more embodiments, at least one second passive element (e.g., second passive element 352 of FIG. 7) in a fourth electrical path (e.g., fourth electrical path 3404 of FIG. 7) that is branched from the first electrical path and is electrically connected to the ground may be included.

According to one or more embodiments, at least one frequency band among the plurality of frequency bands may be determined through element values of the at least one first passive element and/or the at least one second passive element.

According to one or more embodiments, the at least one first passive element and/or the at least one second passive element may include at least one inductor and/or at least one capacitor.

According to one or more embodiments, the substrate may include a plurality of layers, and the first conductive pad and the second conductive pad may be a first layer among the plurality of layers, and may be electrically connected to a conductive layer and a conductive via (e.g., conductive via (CV) of FIG. 13) in at least one layer excluding the first layer.

According to one or more embodiments, the coupling amount of the second coupling area may be determined based on at least one of the shape, the size, and the number of conductive layers at each of the plurality of layers.

According to one or more embodiments, the antenna structure may include a dielectric substrate (e.g., dielectric substrate 301 of FIG. 3B), and the first radiator and/or the second radiator may include a conductive pattern of the dielectric substrate.

According to one or more embodiments, the housing may include a front cover (e.g., front cover 202 of FIG. 2A) and a rear cover (e.g., rear cover 211 of FIG. 3A), the substrate may be in space (e.g., internal space 2101 of FIG. 3A) between the front cover and the rear cover, and the antenna structure may be between the rear cover and the substrate.

According to one or more embodiments, the antenna structure may be attached to the inner surface (e.g., inner surface 2111 of FIG. 4) of the rear cover.

According to one or more embodiments, a display (e.g., display 201 of FIG. 2A) in the space and to be visible from the outside of the electronic device through at least a portion of the front cover may be included.

According to one or more embodiments, the at least one frequency band may include the first frequency band with the range of 600 MHz to 960 MHz that operates through the first radiator, the second frequency band with the range of 1700 MHz to 2200 MHz that operates through the second radiator, and the third frequency band that operates in the frequency band with the range of 2300 MHz to 2800 MHz.

According to one or more embodiments, an electronic device may include a housing (e.g., housing 210 of FIG. 3A), a substrate (e.g., substrate 340 of FIG. 4) including wireless communication circuitry (e.g., wireless communication circuitry (F) of FIG. 4) and ground (e.g., ground (G) of FIG. 4), and an antenna structure (e.g., antenna structure 300 of FIG. 4) that at least partially overlaps the substrate when the substrate is viewed from above, wherein the antenna structure may include a first radiator (e.g., first radiator 310 of FIG. 4) electrically connected to the wireless communication circuitry through a first point (e.g., first point (L1) of FIG. 4) of the substrate and a second radiator (e.g., second radiator 320 of FIG. 4) electrically connected to the ground through a second point (e.g., second point (L2) of FIG. 4) of the substrate, the first radiator and the second radiator may at least partially form a first coupling structure (e.g., first coupling area (C1) of FIG. 4), the substrate may include a second coupling structure (e.g., second coupling area (C2) of FIG. 4) in an electrical path that electrically connects the first point and the second point, when the substrate is viewed from above, the first coupling structure and the second coupling structure may be configured to at least partially overlap, and the wireless communication circuitry may be configured to transmit and/or receive wireless signals in a plurality of frequency bands through the first radiator and the second radiator.

According to one or more embodiments, the substrate may include a first conductive pad (e.g., first conductive pad 341 of FIG. 4) electrically connected to the first point and second conductive pad (e.g., second conductive pad 342 of FIG. 4) electrically connected to the second point, and the second coupling structure may be configured through close layout of the first conductive pad and the second conductive pad.

According to one or more embodiments, the second coupling structure may include a capacitor (e.g., capacitor 343 of FIG. 11A), which has a specific capacitance value, in the electrical path.

According to one or more embodiments, at least one frequency band among the plurality of frequency bands may be determined based on the coupling amount of the second coupling structure.

Embodiments of the disclosure disclosed in the present specification and drawings are only specific examples presented to easily explain the technical contents according to an embodiment of the disclosure and to help understanding of the embodiment of the disclosure, and are not intended to limit the scope of the embodiment of the disclosure. Therefore, the scope of one or more embodiments of the disclosure should be interpreted as including all changes or modifications derived based on the technical spirit of one or more embodiments of the disclosure in addition to the embodiments disclosed herein.

What is claimed is:

1. An electronic device comprising:
a housing;
a substrate including wireless communication circuitry and a ground; and
an antenna structure that at least partially overlaps the substrate,
wherein the antenna structure includes:
a first radiator electrically connected to the wireless communication circuitry through a first point of the substrate; and
a second radiator electrically connected to the ground through a second point of the substrate,
wherein the first radiator and the second radiator at least partially form a first coupling area,
wherein the substrate includes:
a first conductive pad electrically connected to the first point; and
a second conductive pad electrically connected to the second point,
wherein the first conductive pad and the second conductive pad at least partially form a second coupling area,
wherein the first coupling area and the second coupling area at least partially overlap, and
wherein the wireless communication circuitry is configured to transmit or receive wireless signals in a plurality of frequency bands through the first radiator and the second radiator.

2. The electronic device of claim 1, wherein at least one frequency band among the plurality of frequency bands is determined based on a coupling amount of the second coupling area.

3. The electronic device of claim 1, wherein, in the first coupling area, the first radiator and the second radiator have a first distance, and
wherein, in the second coupling area, the first conductive pad and the second conductive pad have a second distance less than the first distance.

4. The electronic device of claim 1, wherein an overlap amount between the first coupling area and the second coupling area exceeds 50% of a total overlap amount.

5. The electronic device of claim 1, wherein the first point is electrically connected to the wireless communication circuitry through a first electrical path at the substrate, and
wherein the second point is electrically connected to the ground through a second electrical path at the substrate.

6. The electronic device of claim 5, wherein the first radiator is electrically connected to a third point of the substrate that is further than the first point from the second point, and
wherein the substrate includes at least one first passive element in a third electrical path that electrically connects the third point and the ground.

7. The electronic device of claim 6, comprising at least one second passive element in a fourth electrical path that is branched from the first electrical path and that is electrically connected to the ground.

8. The electronic device of claim 7, wherein at least one frequency band among the plurality of frequency bands is determined through element values of the at least one first passive element or the at least one second passive element.

9. The electronic device of claim 7, wherein the at least one first passive element or the at least one second passive element includes at least one inductor or at least one capacitor.

10. The electronic device of claim 1, wherein the substrate includes a plurality of layers, and
wherein the first conductive pad and the second conductive pad are included in a first layer among the plurality of layers, and
wherein the first conductive pad and the second conductive pad are electrically connected through a conductive layer and a conductive via in at least one layer excluding the first layer.

11. The electronic device of claim 10, wherein a coupling amount of the second coupling area is determined based on at least one of a shape, a size, and a number of conductive layers at each of the plurality of layers.

12. The electronic device of claim 1, wherein the antenna structure includes a dielectric substrate, and
wherein the first radiator or the second radiator includes a conductive pattern at the dielectric substrate.

13. The electronic device of claim 1, wherein the housing includes a front cover and a rear cover,
wherein the substrate is in a space between the front cover and the rear cover, and
wherein the antenna structure is between the rear cover and the substrate.

14. The electronic device of claim 13, wherein the antenna structure is attached to an inner surface of the rear cover.

15. The electronic device of claim 13, further comprising a display in the space and to be visible from an outside of the electronic device through at least a portion of the front cover.

16. The electronic device of claim 8, wherein the at least one frequency band includes:
a first frequency band with a range of 600 MHz to 960 MHz that operates through the first radiator,
a second frequency band with the range of 1700 MHz to 2200 MHz that operates through the second radiator, and
a third frequency band that operates in a frequency band with the range of 2300 MHz to 2800 MHz.

17. An electronic device comprises:
a substrate including wireless communication circuitry and a ground; and
an antenna structure that at least partially overlaps the substrate,
wherein the antenna structure includes:
a first radiator electrically connected to the wireless communication circuitry through a first point of the substrate, and
a second radiator electrically connected to the ground through a second point of the substrate,
wherein the first radiator and the second radiator at least partially form a first coupling structure,
wherein the substrate includes a second coupling structure in an electrical path that electrically connects the first point and the second point,
wherein the first coupling structure and the second coupling structure at least partially overlap, and
wherein the wireless communication circuitry is configured to transmit or receive wireless signals in a plurality of frequency bands through the first radiator and the second radiator.

18. The electronic device of claim 17, wherein the substrate includes a first conductive pad electrically connected to the first point and a second conductive pad electrically connected to the second point, and
wherein the second coupling structure is configured through a close layout of the first conductive pad and the second conductive pad.

19. The electronic device of claim 17, the second coupling structure includes a capacitor in the electrical path.

20. The electronic device of claim 17, wherein at least one frequency band among the plurality of frequency bands is determined based on a coupling amount of the second coupling structure.
